(19) United States
(12) Patent Application Publication
(10) Pub. No.: US 2008/0055696 A1
(43) Pub. Date: Mar. 6, 2008

(54) FOCUSING MECHANISM FOR A LENS MODULE AND FOCUSING METHOD FOR SAME

(75) Inventors: HAI-HUNG WEN, Chu-Nan (TW); WEN-SHIU LIN, Chu-Nan (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ALTUS TECHNOLOGY INC., Chu-Nan (TW)

(21) Appl. No.: 11/556,513

(22) Filed: Nov. 3, 2006

(30) Foreign Application Priority Data
Sep. 1, 2006 (TW) 95132397

(51) Int. Cl. G02B 26/00

(52) U.S. Cl. 359/237

(57) ABSTRACT

An exemplary focusing mechanism (100) for focusing a lens module includes a testing apparatus (10) and a processor (20), the testing apparatus includes a first testing chart (12) and a second testing chart (14), the first testing chart and the second testing chart are movably placed in an incident light path of the lens module, the processor is connected to the testing apparatus. Two exemplary focusing methods for focusing a lens module are also provided, each method using the focusing system.

### BACKGROUND OF THE INVENTION

1. Field of the Invention

The present invention relates generally to focusing mechanisms for lens modules and focusing methods, and, more particularly, to a focusing mechanism for lens modules that uses hyperfocal distance.

2. Description of Related Art

With the ongoing development of micro-circuitry and multimedia technologies, digital cameras are now in widespread use. High-end portable electronic devices, such as mobile phones and personal digital assistants (PDAs), are being developed to be increasingly multi-functional. Many of these portable electronic devices are now equipped with a digital camera module. Such electronic devices enable consumers to enjoy capturing digital pictures anytime and anywhere.

In a digital camera module, the quality of the lens module is a very important factor in determining the quality of the pictures captured by the camera module. To improve picture quality, the lens module needs to be focused to have a maximum field depth before being mounted to the portable electronic device.

Hyperfocal distance is often used in focusing lens modules. During the manufacture of a lens module, the hyperfocal distance of the lens module is measured. The lens module is then focused at a point where a distance between the lens module and the point equals the hyperfocal distance of the lens module. The components of the lens module are then secured in this state. In this way, the field depth of the lens module is adjusted to be at a maximum, extending from half of the hyperfocal distance to an infinite distance. Thus when the lens module is mounted in a digital camera module of a portable electronic device and used to take photos, the digital camera module can take high quality pictures without requiring a changeable focus.

A typical method for measuring the hyperfocal distance of a lens module includes these steps: placing the lens module in a testing apparatus; placing a chart in the testing apparatus at the greatest possible distance from the lens module thus allowing the assumption that the distance between the lens module and the chart is infinite; using the lens module to screen the chart; and finally using the testing apparatus to measure the field depth of the lens module, wherein a distance between the lens module and the closest limit of the field depth of the lens module can be considered to be the hyperfocal distance of the lens module. However, assuming that the distance between the lens module and the chart is infinite can result in errors.

Therefore, a new focusing mechanism for lens modules that uses hyperfocal distance and a new focusing method are desired in order to overcome the above-described shortcomings.

### SUMMARY OF THE INVENTION

In one preferred embodiment, a focusing mechanism for focusing a lens module includes a testing apparatus and a processor, the testing apparatus includes a first testing chart and a second testing chart, the first testing chart and the second testing chart are movably placed in an incident light path of the lens module, the processor is connected with the testing apparatus. Preferred focusing methods for focusing a lens module using the focusing system are also provided.

Other advantages and novel features will become more apparent from the following detailed description when taken in conjunction with the accompanying drawings.

### BRIEF DESCRIPTION OF THE DRAWINGS

The components in various of the drawings are not necessarily drawn to scale, the emphasis instead being placed upon clearly illustrating the principles of the lens module. Moreover, in the drawings, like reference numerals designate corresponding parts throughout several of the views.

FIG. 1 is a block diagram of a focusing mechanism in accordance with a preferred embodiment of the present invention.

FIG. 2 is a flow chart of a focusing method in accordance with a first embodiment of the present invention.

FIG. 3 is a schematic diagram of aspects of the focusing method in accordance with the first embodiment of the present invention.

FIG. 4 is a flow chart of a focusing method in accordance with a second embodiment of the present invention.

FIG. 5 is a schematic diagram of aspects of a close focusing mode of the focusing method in accordance with the second embodiment of the present invention.

FIG. 6 is a schematic diagram of aspects of a far focusing mode of the focusing method in accordance with the second embodiment of the present invention.

FIG. 7 is a graph contrasting a first modulation transfer frequency with a second modulation transfer frequency in the focusing method in accordance with the first embodiment and the second embodiment of the present invention.

### DETAILED DESCRIPTION OF THE INVENTION

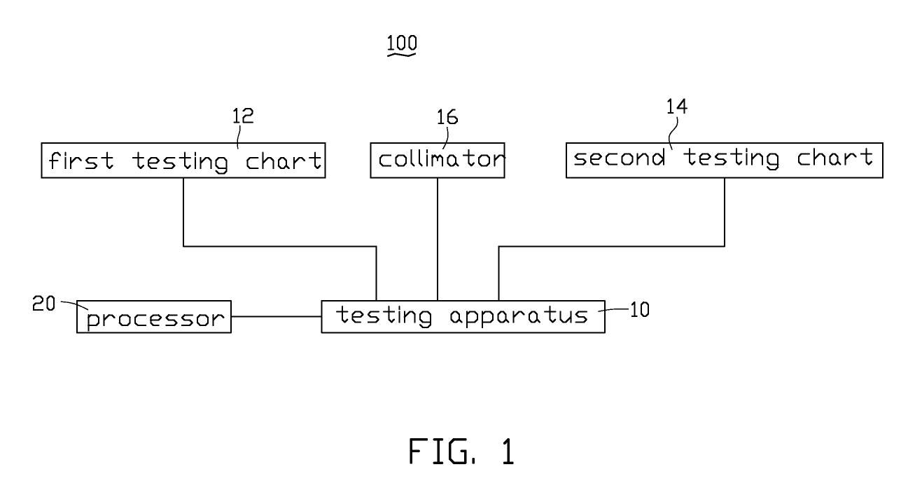

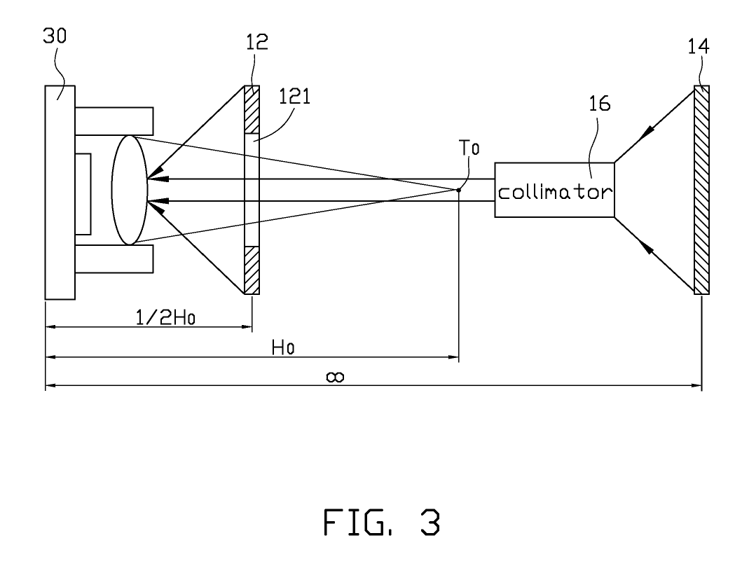

Referring now to the drawings in detail, FIG. 1 and FIG. 3 show aspects of a focusing mechanism 100 in accordance with a preferred embodiment of the present invention. The focusing mechanism 100 includes a testing apparatus 10 and a processor 20. The focusing mechanism 100 is used to focus a lens module 30.

The testing apparatus 10 includes a first testing chart 12, a second testing chart 14, and a collimator 16. The first testing chart 12, the second testing chart 14 and the collimator 16 can be individually detachably mounted on the testing apparatus 10. An aperture 121 is defined in a central portion of the first testing chart 12. In this embodiment, the processor 20 can be a computer, a single chip, a solid state circuit, or any other appropriate information processing device that can be connected with the testing apparatus 10. The processor 20 controls the testing apparatus 10 and processes data collected by the testing apparatus 10.

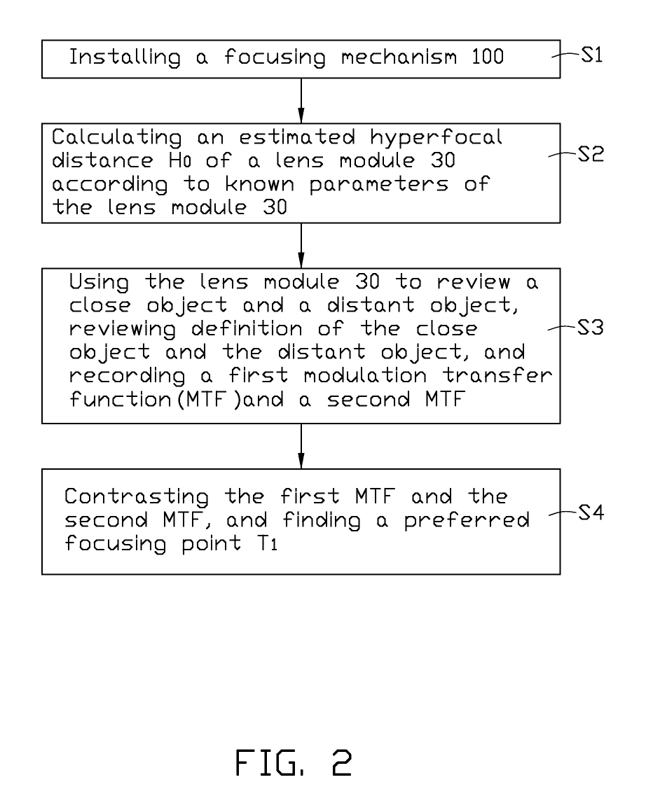

Referring FIG. 2, a focusing method in accordance with a first embodiment of the present invention is used by the focusing mechanism 100 to focus the lens module 30. Parameters of the lens module 30 are adjusted to focus the lens module 30 at a perfect focusing point T where a distance between the lens module 30 and the focusing point T equals the hyperfocal distance H of the lens module 30. In this way, the field depth of the lens module 30 is adjusted to have the maximum possible range, one extending from half of the hyperfocal distance to an infinite distance. When the lens module 30 is mounted in a digital camera module of a portable electronic device and used to take photos, the digital camera module can take high quality photos without changing its focus. The focusing method in accordance with a first embodiment of the present invention includes the following steps:

Installing a focusing mechanism 100 (step S1). Referring to FIG. 3, a focusing mechanism 100 is provided, and the testing apparatus 10 is connected with the processor 20. The first testing chart 12, the second testing chart 14 and the collimator 16 are all mounted on the testing apparatus 10; the second testing chart 14 is aligned with the aperture 121 of the first testing chart 12; and the collimator 16 is mounted between the first testing chart 12 and the second testing chart 14.

Calculating an estimated hyperfocal distance H₀ of a lens module 30 according to known parameters of the lens module 30 (step S2). A lens module 30 is installed on the testing apparatus 10; the testing apparatus 10 measures some parameters of the lens module 30 such as focusing distance f, aperture modulus F and diameter c of a dispersing circle; and these parameters are transmitted to the processor 20. The processor 20 calculates and produces an estimated hyperfocal distance H₀ of the lens module 30 according to these parameters. The estimated hyperfocal distance H₀ can be calculated using H₀=f+f²/(cF). Generally f is considered insignificantly small compared to f²/(cF) thus the formula can be simplified to H₀=f²/(cF).

Using the lens module 30 to view a close object and a distant object, viewing definitions of the close object and the distant object, and recording a first modulation transfer function (MTF) and a second MTF (step S3). The lens module 30 is focused at a point T₀ where a distance between the lens module 30 and the point T₀ equals the estimated hyperfocal distance H₀ of the lens module 30. The first testing chart 12, the second testing chart 14 and the collimator 16 are movably placed in an incident light path of the lens module 30. A distance between the first testing chart 12 and the lens module 30 equals half of H₀, and the second testing chart 14 and the lens module 30 are separated by as great a distance as possible. The collimator 16 is placed between the first testing chart 12 and the second testing chart 14. The second testing chart 14 is aligned with the aperture 121. In this way the lens module 30 views the first testing chart 12 directly and the second testing chart 14 via the collimator 16 and the aperture 121.

The processor 20 controls a lens barrel (not shown) of the lens module 30 to rotate relative to the testing apparatus 10. When the lens barrel is rotating, the length of the lens barrel changes, therefore distances between optical components mounted in the lens barrel such as lenses (not shown) and an image sensor (not shown) are changed, and the lens module 30 is focused. Rotation of the lens barrel can change the lens barrel length by, for example, screw/thread type engagement between one section of the lens barrel and another section of the lens barrel. Definitions of objects viewed by the lens module 30 are calculated by the processor 20. A first MTF is used to represent a transformation of the definition of the first testing chart 12 screened by the lens module 30 and recorded by the processor 20. A second MTF is used to represent a transformation of the definition of the second testing chart 14 screened by the lens module 13 via the collimator 16 and the aperture 121 and recorded by the processor 20.

Contrasting the first MTF and the second MTF, and finding a preferred focusing point T₁ (step S4). Graphs of the values of the first MTF and the second MTF relative to the number of lens barrel rotations needed to achieve this level of focus are drawn by the processor 20. According to the theory of hyperfocal distance, when the lens module 30 is focused at the point T where a distance between the lens module 30 and the point T equals the hyperfocal distance H of the lens module 30, the field depth of the lens module 30 has the largest possible range, extending from half of the hyperfocal distance to an infinite distance. Therefore when the lens module 30 is focused at point T₁, the first testing chart 12 and the second testing chart 14 screened by the lens module 30 both have high definition.

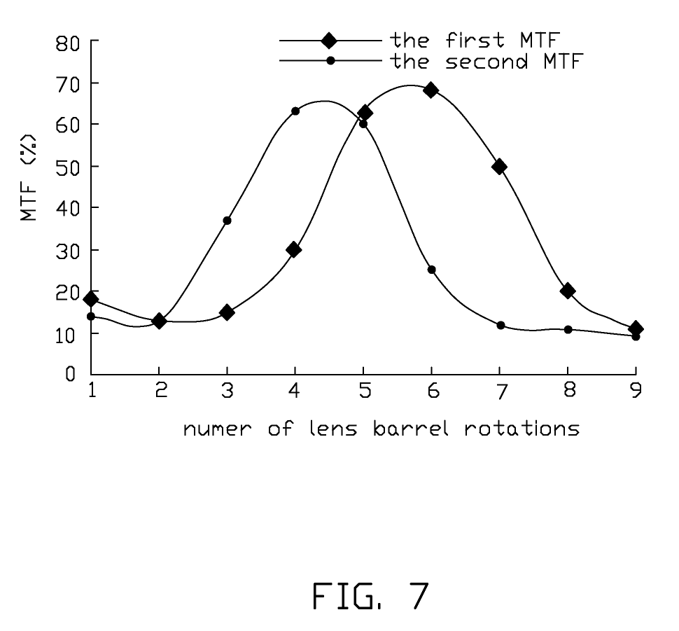

Referring now to FIG. 7, the processor contrasts the graphs of the first MTF and the second MTF, and finds a zone of a certain width in which the first MTF and the second MTF both achieve a desired level of definition quality. Generally, an MTF represents a definition of an optical component, and a larger attributive value of an MTF represents a higher definition. When attributive values of the first MTF and the second MTF are both more than 50%, a definition of the lens module 30 is usually adequate for screening, and thus the lens module 30 is considered successfully focused. According to this theory, an intersection of the graphs of the first MTF and the second MTF in a zone of a certain width where attributive values of the first MTF and the second MTF are both more than 50% corresponds with a preferred focusing state of the lens module 30.

The preferred focusing state shown by the intersection of the first MTF and the second MTF corresponds to a number of revolutions of the lens barrel X. When the lens barrel rotates through X revolutions, the lens module 30 becomes focused at a focusing point T₁. In this state the attributive values of the first MTF and the second MTF are both more than 50%, thus each of the first testing chart 12 and the second testing chart 14 screened by the lens module 30 has a high definition.

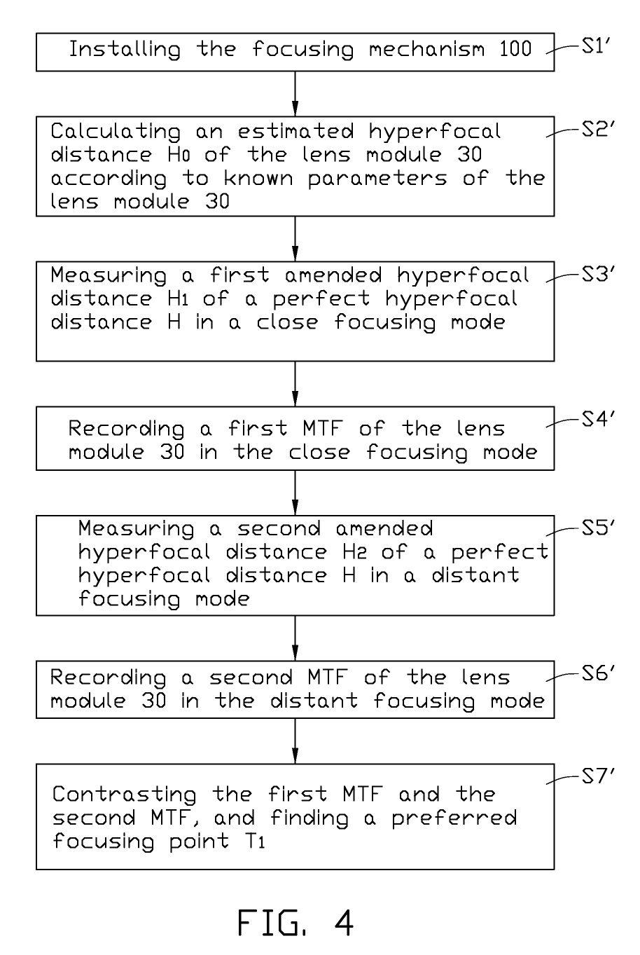

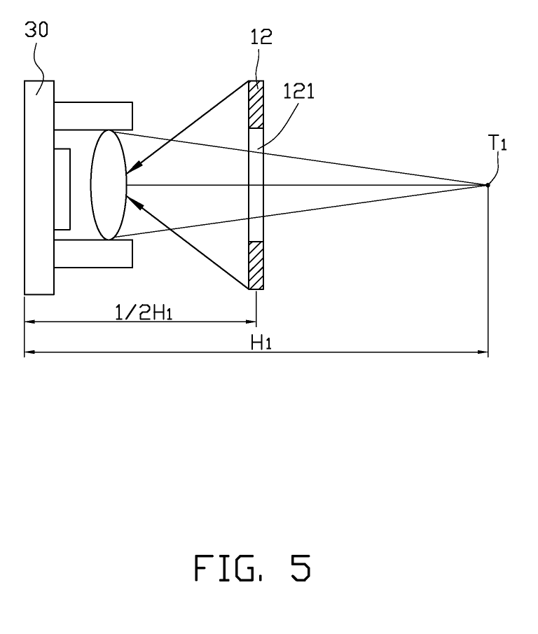

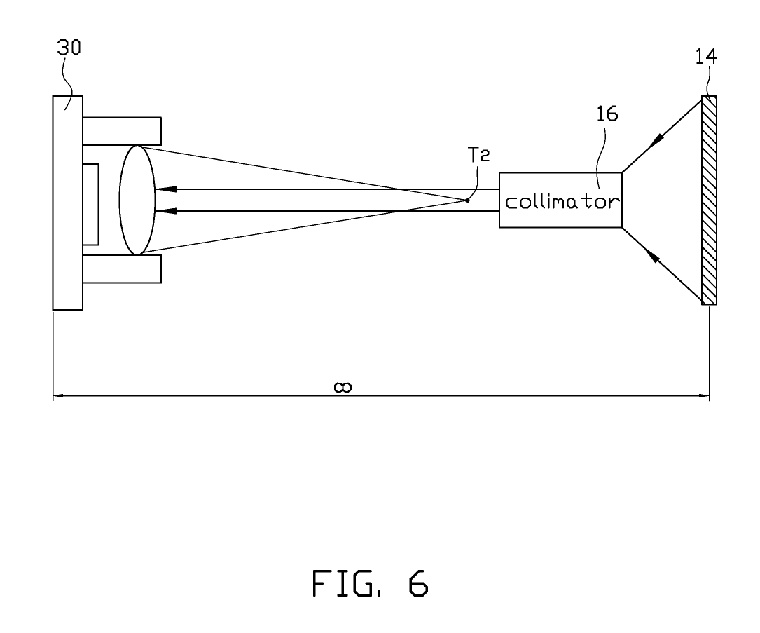

Also referring FIG. 4, FIG. 5 and FIG. 6, the focusing method in accordance with a second embodiment of the present invention includes the following steps:

Installing the focusing mechanism 100 (step S1′). A focusing mechanism 100 is provided, and the testing apparatus 10 is connected with the processor 20.

Calculating an estimated hyperfocal distance H₀ of the lens module 30 according to known parameters of the lens module 30 (step S2′). This step is similar to step S2 of the focusing method in accordance with the first embodiment of the present invention.

Measuring a first amended hyperfocal distance H₁ of a perfect hyperfocal distance H in a close focusing mode (step S3′). The lens module 30 is focused at a point T₀ where a distance between the lens module 30 and the point T₀ equals the estimated hyperfocal distance H₀ of the lens module 30. The first testing chart 12 is mounted on the testing apparatus 10 and movably placed in an incident light path of the lens module 30 so that a distance between the first testing chart 12 and the lens module 30 equals H₀/2; the first testing chart 12 is moved back and forth in the incident light path of the lens module 30; and the lens module 30 views the first testing chart 12.

Definition of the first testing chart 12 is viewed via the processor 20. According to the theory of hyperfocal distance, when the first testing chart 12 is moved from a location distant from the lens module 30 to a location close to the lens module 30 where a distance between the closer location and the lens module 30 is less than a certain limit, a definition of the first testing chart 12 as viewed by the lens module 30 becomes poor. On the other hand, when the first testing chart 12 moves from a close location to a distant location where a distance between the close location and the lens module 30 is greater than the limit, a definition of the first testing chart 12 as viewed by the lens module 30 improves. This length is recorded as the front field depth d₁ of the lens module 30 by the processor 20. Because the front field depth d₁ of the lens module 30 is equal to H/2 when the lens module 30 is focused at a perfect focusing point T where a distance between the lens module 30 and the focusing point T equals the hyperfocal distance H of the lens module 30, the first amended hyperfocal distance H₁ can be calculated according to H₁=2d₁.

Recording a first MTF of the lens module 30 in the close focusing mode (step S4′). The lens module 30 is focused at a point T₁ where a distance between the lens module 30 and the point T₁ equals the first amended hyperfocal distance H₁ of the lens module 30. The first testing chart 12 is placed in an incident light path of the lens module 30, such that a distance between the first testing chart 12 and the lens module 30 equals half of H₁. The lens module 30 screens the first testing chart 12 again, and the focusing point of the lens module 30 is adjusted via rotation of the lens barrel of the lens module 30, in similar fashion to step S3 of the focusing method in accordance with the first embodiment of the present invention. When the focusing point of the lens module 30 is adjusted, a first MTF similar to the first MTF in the focusing method in accordance with the first embodiment of the present invention is used to represent a transformation of the definition of the first testing chart 12 viewed by the lens module 30 and recorded by the processor 20.

Measuring a second amended hyperfocal distance H₂ of a perfect hyperfocal distance H in a distant focusing mode (step S5′). The lens module 30 is focused at a point T₀, and the second testing chart 14 and the collimator 16 are placed in an incident light path of the lens module 30. A distance between the second testing chart 14 and the lens module 30 is made as great as possible. The collimator 16 is placed between the lens module 30 and the second testing chart 14. Adjusting the focusing point of the lens module 30 is performed via rotation of the lens barrel, in similar fashion to step S3 of the focusing method in accordance with the first embodiment of the present invention. The lens barrel 30 is used to screen the second testing chart 14 via the collimator 16.

A definition of the second chart 14 as reviewed by the lens module 30 is determined by the processor 20. In the theory of hyperfocal distance, the back field depth equals an infinite distance when the lens module 30 is focused at the perfect focusing point T where a distance between the lens module 30 and the focusing point T equals the hyperfocal distance H of the lens module 30. Therefore when the focusing point of the lens module 30 is closer to the perfect focusing point T, a definition of the second testing chart 14 screened by the lens module 30 improves. When the definition of the second testing chart 14 screened by the lens module 30 is at its best, a distance between the lens module 30 and an instantaneous focusing point are recorded as a second amended hyperfocal distance H₂.

Recording a second MTF of the lens module 30 in the distant focusing mode (step S6′). The lens module 30 is focused at a point T₂ where a distance between the lens module 30 and the point T₂ equals the second amended hyperfocal distance H₂ of the lens module 30. The second testing chart 14 and the collimator 16 are movably placed in an incident light path of the lens module 30 in a manner similar to that of the placement of the second testing chart 14 and the collimator 16 in step S5′. The focusing point of the lens module 30 is varied about T₂ by rotating the lens barrel in similar fashion to step S3 of the focusing method in accordance with the first embodiment of the present invention, and using the lens barrel 30 to review the second testing chart 14 via the collimator 16. When the focusing point of the lens module 30 is changed, a second MTF similar to the second MTF in the focusing method in accordance with the first embodiment of the present invention is used to represent a transformation of the definition of the second testing chart 14 reviewed by the lens module 30 and recorded by the processor 20.

Contrasting the first MTF and the second MTF, and finding a preferred focusing point T₁ (step S7′). This step is similar to step S4 of the focusing method in accordance with the first embodiment of the present invention.

Additionally, in the focusing methods in accordance with both the first embodiment and the second embodiment of the present invention, the graphs of the first MTF and the second MTF can be determined by the processor 20. In the focusing method in accordance with the second embodiment of the present invention, the second amended hyperfocal distance H₂ of the perfect hyperfocal distance H and the second MTF can be recorded, and the steps can be performed in this order: S1′, S2′, S5′, S6′, S3′, S4′, S7′.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A focusing mechanism for focusing a lens module, comprising:
a testing apparatus, the testing apparatus including a first testing chart and a second testing chart, the first testing chart and the second testing chart being movably placed in an incident light path of the lens module; and
a processor, the processor being connected with the testing apparatus.

2. The focusing mechanism as claimed in claim 1, wherein the testing apparatus includes a collimator, and the collimator is placed between the first testing chart and the second testing chart.

3. The focusing mechanism as claimed in claim 1, wherein a central portion of the first testing chart defines an aperture.

4. A focusing method for focusing a lens module, comprising:
providing a focusing mechanism;
calculating an estimated hyperfocal distance of the lens module using known parameters of the lens module;
using the lens module to review a close object and a distant object, reviewing definitions of the close object and the distant object, and recording a first modulation transfer function (MTF) and a second MTF; and
contrasting the first MTF and the second MTF, and finding a preferred focusing point accordingly.

5. The focusing method as claimed in claim 4, wherein the focusing mechanism includes a testing apparatus, the testing apparatus includes a collimator, a first testing chart, and a second testing chart, the first testing chart, the second testing chart and the collimator are placed in an incident light path of the lens module, with the collimator between the first testing chart and the second testing chart.

6. The focusing method as claimed in claim 4, wherein the estimated hyperfocal distance of the lens module is defined as H₀ and is calculated according to a focusing distance f, an aperture modulus F and a diameter c of a dispersing circle of the lens module, and a formula for calculating the estimated hyperfocal distance H₀ is selected from the group consisting of H₀=f+f²/(cF) and H₀=f²/(cF).

7. The focusing method as claimed in claim 6, wherein the close object screened by the lens module is the first testing chart, the distant object screened by the lens module is the second testing chart, a distance between the first testing chart and the lens module equals half of H₀, and the second testing chart is placed as far as possible from the lens module.

8. The focusing method as claimed in claim 4, wherein the focusing mechanism includes a processor, the first MTF represents a transformation of the definition of the first testing chart as viewed by the lens module, the second MTF represents a transformation of the definition of the second testing chart as viewed by the lens module, and the first MTF and the second MTF are both recorded by the processor.

9. The focusing method as claimed in claim 8, wherein a graph of focus variation of the first MTF and a graph of focus variation of the second MTF intersect, and a zone of a certain width at the intersection where attributive values of the first MTF and the second MTF are both more than 50% corresponds with a preferred focusing state of the lens module.

10. The focusing method as claimed in claim 9, wherein the focus variation graph of each of the first MTF and the second MTF is plotted according to a number of revolutions of a lens barrel of the lens module required to obtain respective attributive values of each of the first MTF and the second MTF.

11. A focusing method for focusing a lens module, comprising:
providing a focusing mechanism;
calculating an estimated hyperfocal distance H₀ of the lens module according to parameters of the lens module;
measuring a first amended hyperfocal distance H₁ of a perfect hyperfocal distance H in a first focusing mode and measuring a second amended hyperfocal distance H₂ of the perfect hyperfocal distance H in a second focusing mode;
focusing the lens module based on the first amended hyperfocal distance H₁ and the second amended hyperfocal distance H₂, and recording a first modulation transfer function (MTF) of the lens module in the first focusing mode and a second MTF of the lens module in the second focusing mode;
contrasting the first MTF and the second MTF, and finding a preferred focusing point accordingly.

12. The focusing method as claimed in claim 11, wherein the estimated hyperfocal distance H₀ of the lens module is calculated according to a focusing distance f, an aperture modulus F and a diameter c of a dispersing circle of the lens module, and a formula for calculating the estimated hyperfocal distance H₀ is selected from the group consisting of H₀=f+f²/(cF) and H₀=f²/(cF).

13. The focusing method as claimed in claim 11, wherein the first focusing mode is a close focusing mode and the second focusing mode is a distant focusing mode.

14. The focusing method as claimed in claim 13, wherein the focusing mechanism includes a testing apparatus, the testing apparatus includes a first testing chart and a second testing chart, the lens module views the first testing chart in the first focusing mode, and the lens module views the second testing chart in the second focusing mode.

15. The focusing method as claimed in claim 13, wherein the first amended hyperfocal distance H₁ is calculated based on a front field depth of the lens module.

16. The focusing method as claimed in claim 13, wherein the second amended hyperfocal distance H₂ is measured based on a definition of the second testing chart when the second testing chart is placed as far as possible away from the lens module and reviewed by the lens module.

17. The focusing method as claimed in claim 11, wherein the focusing mechanism includes a processor, the first MTF represents a transformation of the definition of the first testing chart screened by the lens module, the second MTF represents a transformation of the definition of the second testing chart screened by the lens module, and the first MTF and the second MTF are both recorded by the processor.

18. The focusing method as claimed in claim 17, wherein a graph of focus variation of the first MTF and a graph of focus variation of the second MTF intersect, and a zone of a certain width at the intersection where attributive values of the first MTF and the second MTF are both more than 50% corresponds with a preferred focusing state of the lens module.

19. The focusing method as claimed in claim 18, wherein the focus variation graph of each of the first MTF and the second MTF is plotted according to a number of revolutions of a lens barrel of the lens module required to obtain respective attributive values of each of the first MTF and the second MTF.
